(19) United States
(12) Patent Application Publication
(10) Pub. No.: US 2017/0006555 A1
(43) Pub. Date: Jan. 5, 2017

(54) TERMINAL, BASE STATION, AND COMMUNICATION METHOD

(71) Applicant: SHARP KABUSHIKI KAISHA, Sakai City (JP)

(72) Inventors: Shigeto SUZUKI, Sakai City (JP); Hiroyuki SAGA, Sakai City (JP); Hirokazu KOBAYASHI, Sakai City (JP); Katsutoshi ISHIKURA, Sakai City (JP); Yuhsuke TAKAGI, Sakai City (JP); Fumiyo SATOH, Sakai City (JP)

(21) Appl. No.: 15/125,632

(22) PCT Filed: Mar. 12, 2015
(86) PCT No.: PCT/JP2015/057326

§ 371 Date: Sep. 13, 2016

(30) Foreign Application Priority Data
Mar. 14, 2014 (JP) 2014-052758

(51) Int. Cl. H04W 52/26; H04W 36/30; H04L 12/26; H04W 52/14

(52) U.S. Cl. CPC H04W 52/26; H04W 52/146; H04W 36/30; H04L 43/16

(57) ABSTRACT

A terminal includes: a transmission power setting unit configured to set transmission powers of two or a greater number of uplink component carriers connecting one or a greater number of base stations; a transmission power control unit configured to control the transmission powers based on information from the transmission power setting unit; and a transmission power summing unit configured to determine a sum of the transmission powers of the uplink component carriers.

### TECHNICAL FIELD

The present invention relates to a terminal, a base station, and a communication method, particularly in LTE-A (Long Term Evolution Advanced).

The subject application claims priority based on the patent application No. 2014-052758 filed in Japan on Mar. 14, 2014 and incorporates by reference herein the content thereof.

### BACKGROUND ART

In LTE-A, which is a mobile telephone communication standard, a communication system is proposed in which two or more component characters (CCs), which are base frequency blocks, are joined to expand the bandwidth. The joining of contiguous or non-contiguous component carriers is known as carrier aggregation (CA). The connection to and communication by a terminal performing carrier aggregation with two base stations is known as a dual connection (dual connectivity), and particularly when the two base stations are of different types, is known as heterogeneous communication.

Patent Reference 1 describes (1) when a cell B supports a part of cell A for the case in which a terminal 200 is located in a serving cell of a base station 100 operating component carriers A and B, the allocation of a high downlink transmission power to cell A and a low downlink transmission power to cell B, and (2) when there exists a base station 1001 operating component carriers A and B and a base station 1002 operating a component carrier C and in which a part of the component carriers A and C overlaps, when the component carrier C is stopped or the power thereof is reduced, the handover of terminal 200 is performed from the component carrier C to the component carrier A or B, while applying the above-noted condition (1).

### PRIOR ART DOCUMENTS

### Patent Document

[Patent Document 1] Japanese Patent Application Publication No. 2013-201576

### SUMMARY OF THE INVENTION

### Problem to Be Solved by the Invention

What is described in Patent Document 1 is carrier aggregation, and reference is also made regarding handover when two base stations exist. However, the transmission power referenced in Patent Document 1 is the downlink transmission power from the base station to the terminal, not the uplink transmission power from the terminal to the base station. In contrast, the transmission power in an embodiment of the present invention is generally the uplink transmission power. Also, although the language of Patent Document 1 references power savings at a base station, it nowhere mentions power savings in a terminal.

The problem for the embodiments of the present invention to solve is that of enabling a power savings in a terminal in the case of a terminal using carrier aggregation and connecting to one or more base stations. Other problems addressed by the embodiments of the present invention will be apparent from the following description.

### Means for Solving the Problems

In a communication in which a terminal and one or more base stations are connected by at least two or more uplink component carriers, a power saving means for transmission powers of the two or more uplink component carriers is provided in the terminal.

### Effect of the Invention

According to an embodiment of the present invention, if a terminal connects to a base station using carrier aggregation, particularly including carrier aggregation dual connectivity, it is possible to effectively achieve a power savings in the terminal.

### BRIEF DESCRIPTIONS OF THE DRAWINGS

FIG. 1 shows the constitution of a communication system according to an embodiment of the present invention.

FIG. 2 shows the frequency relationships between P_{Cell} and S_{Cell}.

FIG. 3 is a table describing handover examples (A), (B), and (C).

FIG. 4A illustrates a first positional relationship between a plurality of macro cells and a plurality of small cells.

FIG. 4B illustrates a second positional relationship between a plurality of macro cells and a plurality of small cells.

FIG. 4C illustrates a third positional relationship between a plurality of macro cells and a plurality of small cells

FIG. 5 is a simplified block diagram showing the constitution of a terminal.

FIG. 6 is a simplified block diagram showing the constitution of a macro base station.

FIG. 7 is a simplified block diagram showing the constitution of a small base station.

FIG. 8 is an operational sequence diagram of a communication system.

### EMBODIMENTS FOR CARRYING OUT THE INVENTION

### First Embodiment

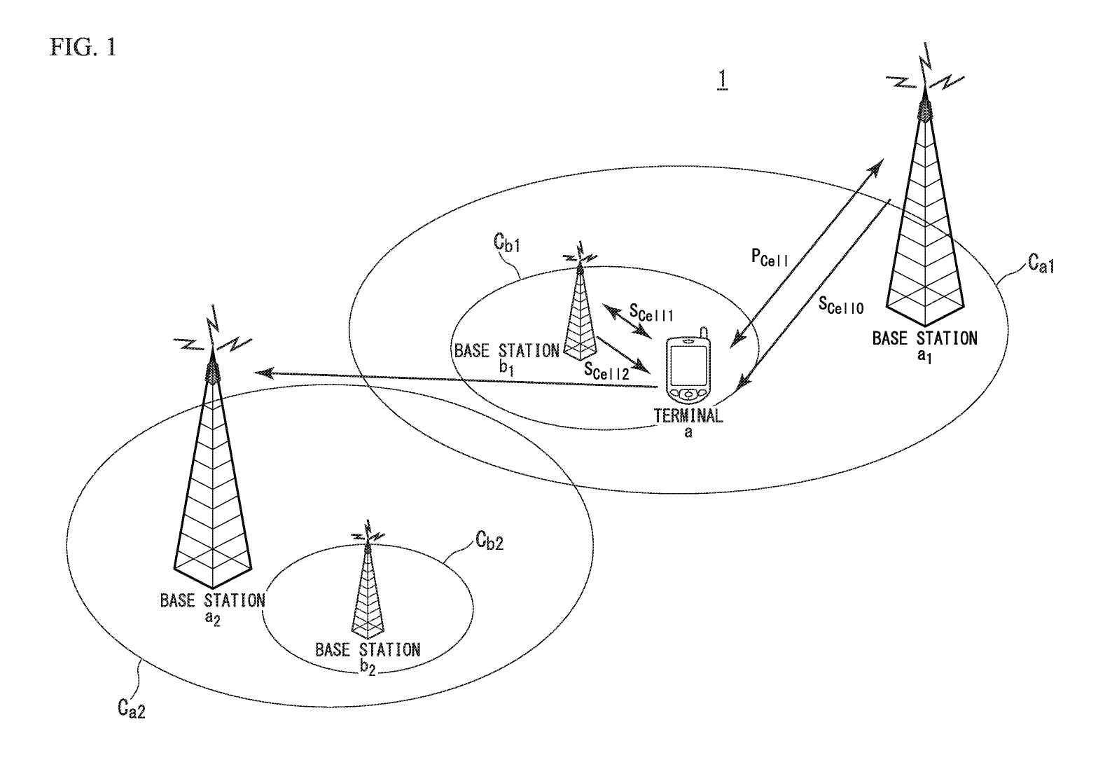

FIG. 1 is shows the general constitution of a communication system 1 according to the embodiment of the present invention. The communication system 1 is constituted to include a terminal a and a base station a₁, a base station a₂, a base station b₁, and a base station b₂.

The terminal a is a user terminal. In FIG. 1, the terminal a is a mobile telephone handset accommodating LTE-A.

The base station al and the base station a₂ are macro base stations (anchor base stations) having a high transmission power, and the coverage areas Cₐ₁ and the coverage area Cₐ₂, respectively. The base station b₁ and the base station b₂ are small base stations (for example, femto base stations, pico base stations, remote radiohead) having a low transmission power, and having the coverage area C_{b1} and the coverage C_{b2}, respectively. FIG. 1 shows how handover is done between two heterogeneous networks.

The terminal a₁, for example, uses carrier aggregation (CA) that simultaneously uses four component carriers (CCs) that are LTE carriers, and can communicate with the base station a₁ and the base station b₁. In the carrier aggregation relationship between the terminal a and the base stations a1 and b₁, one of the four component carriers is a primary component carrier (PCC) and the other three are secondary component carriers (SCCs). However, even a component carrier that plays a PCC role in a small cell will be grouped together with and will be referred to herein as a secondary component carrier. Between the terminal a and the base station a₁ carrier aggregation is done using a primary component carrier and one secondary component carrier. The serving cells of these component carriers are referred to as P_{Cell} (primary cell) and S_{cell0} (secondary cell). Between the terminal a and the base station b₁, carrier aggregation is performed using two secondary component carriers. The serving cells of these component carriers are referred to as S_{Cell1} and S_{Cell2}. In the following, the above-noted serving cells might be used to refer to the corresponding component carriers. In FIG. 1, the reference symbol P_{Cell} and the reference symbols S_{Cell0} to S_{Cell2} indicate a component carrier link (circuit) corresponding to the serving cells.

The foregoing is exemplary and, the terminal a can communicate with the base station al by using, in addition to P_{Cell} and Scam, an arbitrary number (including zero) of uplinks and downlinks, or a paired up/downlink S_{Cell}. The terminal a can communicate with the base station b₁ by using, in addition to S_{Cell1} and S_{Cell2}, an arbitrary number of uplinks and downlinks, or a paired up/downlink S_{Cell}.

In FIG. 1, terminal a connects to the base station a₁ by P_{Cell} corresponding to the uplink component carrier and the downlink component carrier that are paired (linked), and connects to the base station al by S_{Cell0} corresponding to the downlink component carrier. The terminal a connects to the base station b₁ by S_{Cell1} corresponding to the uplink component carrier and the downlink component carrier that are paired, and connects to the base station b₁ by S_{Cell2} corresponding to the downlink component carrier.

In FIG. 1, the terminal a performs a search of surrounding cells, and particularly a search for the base station a₂.

Although the communication system 1 of the present embodiment is an FDD (frequency-division duplex) system, the present embodiment can be applied also to a TDD (time-division duplex) system.

In the above-described connections, OFDMA (orthogonal frequency-division multiple access) is used for downlink communication, and SC-FDMA (single-carrier frequency-division multiple access) is using for uplink communication. An uplink control signal from the terminal a to the base stations a₁ and b₁ is transmitted using the component carrier PUCCH (Physical Uplink Control Channel) and an uplink data signal (uplink shared data) is transmitted using the component carrier PUSCH (Physical Uplink Shared Channel). In the above-described connections, downlink control signals from the base stations a₁ and b₁ to the terminal a are transmitted using the component carrier PDCCH (Physical Downlink Control Channel) and downlink data signals are transmitted by the component carrier PDSCH (Physical Downlink Shared Channel). As an example, the terminal a can communicate with the base station al using the 10-MHz-bandwidth uplink P_{Cell} component carrier at the frequency f₁ and the 10-MHz-bandwidth downlink P_{Cell} component carrier at the frequency f₂, and also using the 10-MHz-bandwidth downlink S_{Cell0} component carrier at the frequency f₃. The terminal a can communicate with the base station b₁ using the 20-MHz-bandwidth uplink S_{Cell1} component carrier at the frequency f₄ and the 20-MHz-bandwidth downlink S_{Cell1} component carrier at the frequency f₅, and also using the 20-MHz-bandwidth downlink S_{Cell2} component carrier at the frequency f₆.

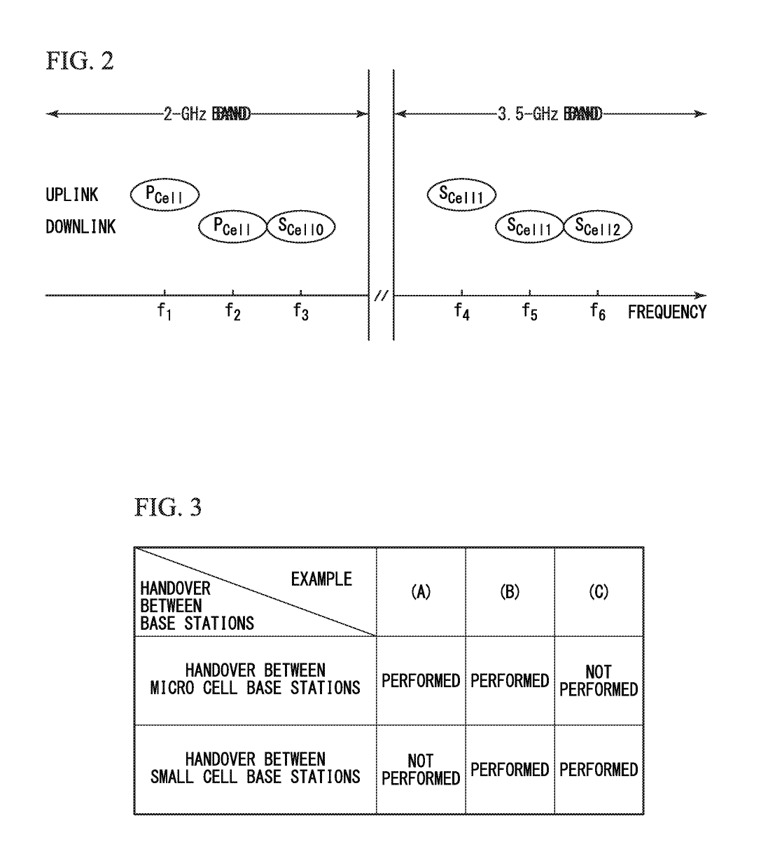

FIG. 2 shows the frequency placement relationship between the above-described P_{Cell}, S_{Cell0}, S_{Cell}, and S_{Cell2}. The horizontal axis represents frequency. The frequencies f₁, f₂, and f₃ are in the 2-GHz band, and the frequencies f₄, f₅, and f₆ are in the 3.5-GHz band. P_{Cell} is the collective name for the paired downlink and uplink component carriers. The same applies to S_{Cell1}. The frequencies f₁ to f₆ may belong to three or a larger number of separate bands. The base station a₁ and the base station b₁ are connected by backhaul, for example, an X interface. Direct communication between base station a₁ and base station b₁ is therefore possible.

FIG. 3 illustrates examples of handover, in which the base station used by the terminal a (FIG. 1) is switched. In the example (A), the terminal a performs handover from the base station a₁ to the base station b₁, but does not perform handover from the base station b₁ to the base station b₂. In the example (B), the terminal a performs handover from the base station a₁ to the base station b₁ and handover from the base station b₁ to the base station b₂. In the example (C), the terminal a does not perform handover from the base station al to the base station b₁, but does perform handover from the base station b₁ to the base station b₂.

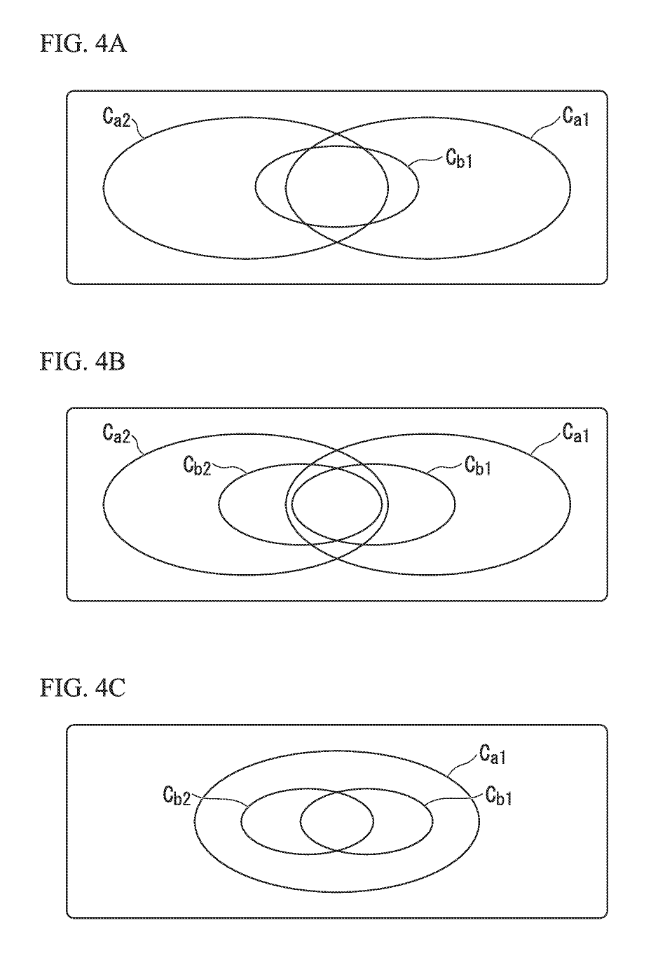

FIG. 4A to FIG. 4C shows the communication area relationships for the cases of examples (A), (B), and (C) of FIG. 3.

FIG. 4A corresponds to the example (A), in which (i) area Cₐ₁ and area Cₐ₂ have an area of partial overlap; (ii) area C_{b1} has an area of partial overlap with area Cₐ₁; (iii) area C_{b1} has an area of partial overlap with area Cₐ₂; and (iv) area C_{b1} has an area of partial overlap with the overlapped area between the area C_{b1} and the area Cₐ₁.

FIG. 4B corresponds to the example (B), in which (i) area Cₐ₁ and area Cₐ₂ have an area of partial overlap: (ii) area C_{b1} is enclosed within area Cₐ₁; (iii) area C_{b2} is enclosed within area Cₐ₂; (iv) area C_{b1} and area Cₐ₂ have an area of partial overlap; and (v) area C_{b1} has an area that does not overlap with area Cₐ₂ and area C_{b2} has an area that does not overlap with area Cₐ₁.

FIG. 4C corresponds to the example (C), in which (i) area Cₐ₁ encloses area C_{b1} and area C_{b2} and (ii) area C_{b1} and area C_{b2} have an area of partial overlap.

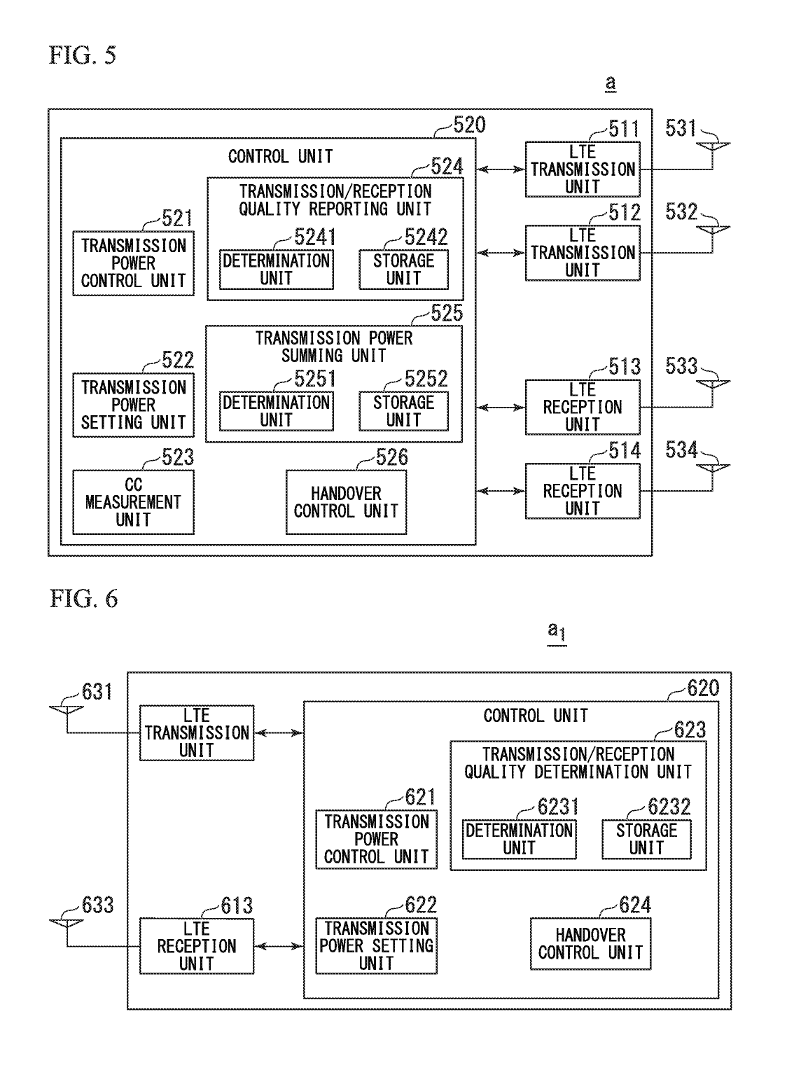

FIG. 5 is a simplified block diagram showing the constitution of the terminal a (FIG. 1).

The terminal a is constituted to include an LTE transmission unit 511, an LTE transmission unit 512, an LTE reception unit 513, an LTE reception unit 514, and a control unit 520. The terminal a has antennas 531 to 534, which are connected to each of the transmission units and reception units. The terminal a also has conventional output devices that output sound, video, and the like, and input devices which accept instructions from a user, although these are omitted from FIG. 5.

The LTE transmission unit 511 and the LTE reception unit 513 are a transmission unit and a reception unit, respectively, for a frequency band A (for example the 2-GHz band). The LTE transmission unit 512 and the LTE reception unit 514 are a transmission unit and a reception unit, respectively, for a frequency band B (for example the 3.5-GHz band).

The terminal a, using the uplink component carrier and the downlink component carrier of P_{Cell} that are paired, transmits and receives signals, respectively, by the LTE transmission unit 511 and the LTE reception unit 513 and, using the downlink component carrier of S_{Cell0}, receives a signal by the LTE reception unit 513. The terminal a, using the uplink component carrier and the downlink component carrier of S_{Cell1} that are paired, transmits and receives signals, respectively, by the LTE transmission unit 512 and the LTE reception unit 514 and, using the downlink component carrier of S_{Cell2}, receives a signal by the LTE reception unit 514. Therefore, terminal a can perform carrier aggregation connection using the two component carriers of P_{Cell} and S_{Cell1} on the uplink and can perform carrier aggregation connection using the four component carriers of P_{Cell}, S_{Cell0}, S_{Cell1}, and S_{Cell2} on the downlink. The terminal a makes a carrier aggregation dual connection to base stations having different system, a macro base station and a small base station. Therefore, the carrier aggregation connection is an intersite carrier aggregation connection.

The control unit 520 is constituted to include a transmission power control unit 521, a transmission power setting unit 522, a component carrier measurement unit 523, a transmission/reception quality reporting unit 524, a transmission power summing unit 525, and a handover control unit 526.

The control unit 520 is constituted to further include a conventional element (not shown) that performs various control regarding communication by the terminal a, such as processing of received data and transmitted data, and carrier frequency control of each transmission unit and reception unit. A part or all of the control unit 520 can be formed into a product using semiconductor circuits as a software product (a software product that is implemented by a CPU of the terminal a executing a program). In implementing a product as integrated circuits, the control unit 520 can be integrated into one or a plurality of semiconductor chips. These points apply also the control unit of the base stations.

The transmission power setting unit 522 sets the transmission power and passes transmission power setting information to the transmission power control unit 521. The transmission power control unit 521, based on the transmission power setting information, sets a parameter of power amplifiers (not shown in FIG. 5) of each of the LTE transmission units 511 and 512. The output signals of the power amplifiers are supplied to each of the antennas 531 and 532, and are transmitted as radio signals therefrom. The power supplied to the antennas 531 and 532 are referred below to transmission power of these antennas. This applies also to the constitution of the control unit of the base station, which will be described below. The transmission power setting unit 522 can set each of the transmission powers of two or a greater number of component carriers belonging to one frequency band. Because the transmission power setting unit 522 is an element that contributes to a reduction of the power consumption, that is, a power savings in the terminal a, the transmission power setting unit 522 is sometimes called a power-reduction processor or a power saving means.

The transmission power summing unit 525 calculates the sum of the transmission power of each of above-described antennas 531 and 532 (hereinafter sometimes referred to as the “uplink transmission power sum value” or the “transmission power sum”). The transmission power sum S_{T} is expressed by the following equation.

S_{T}=Tₐ₁+T_{b1} (1)

In the above, Tₐ₁ is the transmission power with respect to the base station a₁, and T_{b1} is the transmission power with respect to the base station b₁ of the terminal a. When the terminal a is communicating with the base station by two or a greater number of component carriers, each of the transmission powers Tₐ₁ and T_{b1} is the sum of the transmission powers regarding each of the component carriers. The larger is the transmission power sum S_{T}, the greater is the increase in the power consumed by the terminal a, and the transmission power sum S_{T} is an indicator of the power consumption of the terminal a.

The determination unit 5251 of the transmission power summing unit 525 determines whether or not the transmission power sum S_{T} has exceeded the threshold T_{HST} stored in the storage unit 5252. The transmission power sum S_{T} being smaller than the threshold T_{HST} means that the overall transmission power by the terminal a with respect to the base stations a₁ and b₁ is small, and within an allowable range. The transmission power sum S_{T} being larger than the threshold T_{HST} means that the overall transmission power of the terminal a is large and exceeds an allowable range, indicating that consideration is required with regard to handing over to another base station or redistribution of the transmission power to the individual component carriers.

The transmission power summing unit 525 passes the transmission power sum S_{T} and each of the transmission powers Tₐ₁ and T_{b1} to the transmission/reception quality reporting unit 524. The transmission/reception quality reporting unit 524, periodically transmits the transmission power sum ST and the individual transmission powers Tₐ₁ and T_{b1} to the base station a₁, which is the anchor base station, via the LTE transmission unit 511 and the antenna 531. The transmission/reception quality reporting unit 524 can periodically transmit the individual transmission powers Tₐ₁ and T_{b1} to the base station al via the LTE transmission unit 511 and the antenna 531, without transmitting the transmission power sum S_{T} at that time.

The storage unit 5252 of the transmission power summing unit 525 temporarily stores the transmission power sum S_{T} and the individual transmission powers Tₐ₁ and T_{b1}, as well as the transmission powers of each component carrier. The determination unit 5251 of the transmission power summing unit 525 determines whether or not the transmission power sum S_{T} exceeds the threshold T_{HST} and also determines whether or not the individual transmission powers Tₐ₁ and T_{b1} exceed a prescribed threshold. The prescribed threshold regarding the individual transmission powers Tₐ₁ and T_{b1} will be described in detail later.

The determination unit 5251 can also determine the relative size of the individual component carrier transmission powers. The transmission power summing unit 525 passes this determination result to the transmission power setting unit 522, and next the transmission power setting unit 522 performs setting of the transmission power of control signals (control data) or data signals (shared data) of the individual uplink component carriers, given consideration to this determination result. The determination unit 5251 of the transmission power summing unit 525 can determine whether the transmission power sum S_{T} has increased by a prescribed amount, after a certain time passed, from the value at the time of the starting of the component carrier connection.

The component carrier measurement unit 523 measures the reception quality Rₐ₁ of the radio signal received via the antenna 533 and the LTE reception unit 513 regarding the transmitted signal of the base station a₁, and the reception quality R_{b1} of the radio signal received via the antenna 534 and the LTE reception unit 514 regarding the transmitted signal of the base station b₁. The component carrier measurement unit 523 can measure the reception quality of the radio signals received using the individual downlink component carriers.

The reception quality of the radio signal measured by the component carrier measurement unit 523 is, for example, the RSRP (reference signal received power) or RSRQ (reference signal received quality) regarding a reference signal transmitted by the base station. The terminal a, for example, based on a CRS (cell-specific reference signal) can measure the RSRP or RSRQ. The component carrier measurement unit 523 calculates the total reception quality S_{R} of the reception qualities Rₐ₁ and R_{b1} (hereinafter sometimes called “downlink reception quality value” or “total reception quality”). The total reception quality S_{R} is expressed by the following equation.

S_{R}=Rₐ₁+R_{b1} (2)

The component carrier measurement unit 523 passes the total reception quality S_{R}, along with the individual reception qualities Rₐ₁ and R_{b1} and the individual component carrier reception qualities, to the transmission/reception quality reporting unit 524.

The determination unit 5241 of the transmission/reception quality reporting unit 524 determines whether or not the total reception quality S_{R} is below the threshold T_{HSR} stored in the storage unit 5242 of the transmission/reception quality reporting unit 524. The total reception quality S_{R} being larger than the threshold T_{HSR} means that the reception quality of the terminal a receiving a radio signal from the base station is good and within an allowable range. The total reception quality S_{R} being smaller than the threshold R_{HSR} means that the reception quality of the terminal a receiving a radio signal from the base station is poor and not allowable.

The storage unit 5242 of the transmission/reception quality reporting unit 524 temporarily stores the reception quality. The transmission/reception quality reporting unit 524 of the terminal a can transmit the total reception quality S_{R} and the individual reception qualities Rₐ₁ and R_{b1}, along with the individual component carrier reception qualities, to the base station a₁.

The transmission/reception quality reporting unit 524 passes this determination result to the transmission power summing unit 522, and next the transmission power summing unit 522 can perform setting of the transmission power of control signals or data signals of the individual uplink component carriers, giving consideration to this determination result. This will be described later.

The handover control unit 526 performs various control of the terminal a regarding handover.

The terminal a, upon receiving a handover instruction from the base station a₁ and searching for a surrounding cell, it can make notification to the currently connected base station al of a base station having a low uplink transmission power toward the base station of a surrounding cell. In this case, a report is made to the currently connected base station a₁, giving priority to base stations having a low uplink transmission power toward surrounding cell the base station and also having a good RSRP or RSPQ. More specifically, a report is made to the base station al from among surrounding base stations simultaneously satisfying the relationships of Equation (3) and Equation (4), in increasing order of uplink transmission power.

S′_{T}<T_{HST} (3)

S′_{R}>T_{HSR} (4)

Equation (3) indicates that the transmission power sum S′_{T} with respect to a surrounding base station is smaller than the threshold T_{HST}, and Equation (4) indicates that the total reception quality S′_{R} with respect from a surrounding base station is larger than the threshold T_{HSR}. The method of setting the priority sequence is not restricted to this. The setting of priority sequence may be made using Equation (3), without using Equation (4).

The closer the terminal a is to a base station, the more fractional transmission power control can be used to use a high uplink transmission power. Conversely, the farther the terminal a is to a base station, the more transmission power control can be used to use a high uplink transmission power.

FIG. 6 is a simplified block diagram showing the constitution of the base station a₁ (FIG. 1). The base station a₁ is connected to a core network, for example, via an S1 interface. The base station a₁ is constituted to include an LTE transmission unit 611, an LTE reception unit 613, and a control unit 620. The base station a₁ has antennas 631 and 633, which are connected to the transmission unit and reception unit, respectively. The LTE transmission unit 611 and the LTE reception unit 613 are a transmission unit and a reception unit for the frequency band A. The base station a₁ uses an uplink component carrier and a downlink component carrier to transmit and receive signals by the LTE transmission unit 611 and the LTE reception unit 613 and uses S_{Cell0} to transmit a signal by the LTE transmission unit 611.

The control unit 620 is constituted to include a transmission power control unit 621, a transmission power setting unit 622, a transmission/reception quality setting unit 623, and a handover control unit 624.

The transmission power control unit 621 controls the transmission power of the antenna 631. The transmission power setting unit 622 sets the transmission power and passes transmission power setting information to the transmission power control unit 621.

The storage unit 6232 of the transmission/reception quality determination unit 623 stores the transmission power sum T_{ST} and the individual transmission powers Tₐ₁ and T_{b1} transmitted from the base station a₁. If the transmission powers Tₐ₁ and T_{b1} are transmitted but the transmission power sum T_{ST} is not transmitted from the terminal a, the storage unit 6232 stores only the transmission powers Tₐ₁ and T_{b1} and determines the transmission power sum T_{ST} from the transmission powers Tₐ₁ and T_{b1}.

The determination unit 6231 of the transmission/reception quality determination unit 623 determines whether or not the transmission power sum T_{ST} exceeds the threshold value T_{HST} stored in the storage unit 6232. The determination unit 6231 also determines whether or not the transmission power Tₐ₁ exceeds a threshold T_{Ha1} or whether the transmission power T_{b1} exceeds a threshold T_{Hb1}, the thresholds T_{Ha1} and T_{Hb1} being expressed as follows.

T_{Ha1}=T_{HST}·Tₐ₁/S_{T} (5)

T_{Hb1}=T_{HST}·T_{b1}/S_{T} (6)

In Equations (5) and (6), the threshold T_{HST} is distributed among the thresholds T_{Ha1} and T_{Hb1} in accordance to the individual transmission powers. It is sufficient that the setting of the thresholds T_{Ha1} and T_{Hb1} can be done by distribution of the threshold T_{HST}, although the distribution in the present embodiment is not restricted to Equations (5) and (6).

If the transmission power sum T_{ST} exceeds the threshold T_{HST} and the transmission power Tₐ₁ exceeds the threshold T_{Ha1}, but the transmission power T_{b1} is less than the threshold T_{Hb1}, the base station a₁ instructs the terminal a and another base station of handover by the terminal a from the base station a₁ to the base station a₂ (this corresponding to the example A). If the transmission power sum T_{ST} exceeds the threshold T_{HST} and also the transmission power Tₐ₁ exceeds the threshold T_{Ha1} and the transmission power T_{b1} exceeds the threshold T_{Hb1}, the base station al instructs the terminal a and anther base station of the handover by the terminal a from the base stations a₁ and b₁ to the base stations a₂ and b₂ (this corresponding to the example B). If the transmission power sum T_{ST} exceeds the threshold T_{HST} and the transmission power Tₐ₁ is below the threshold T_{Ha1}, but the transmission power T_{b1} exceeds the threshold T_{Hb1}, the base station a₁ instructs the terminal a and another base station of handover by the terminal a from the base station b₁ to the base station b₂ (this corresponding to the example C).

The base station a₁, in addition to the transmission power sum T_{ST} and the transmission powers Tₐ₁ and T_{b1}, can determine from what base station to what base station handover of the terminal a is to be done, giving consideration to total reception quality S_{R} received from the terminal a and to the individual reception qualities Rₐ₁ and T_{b1}.

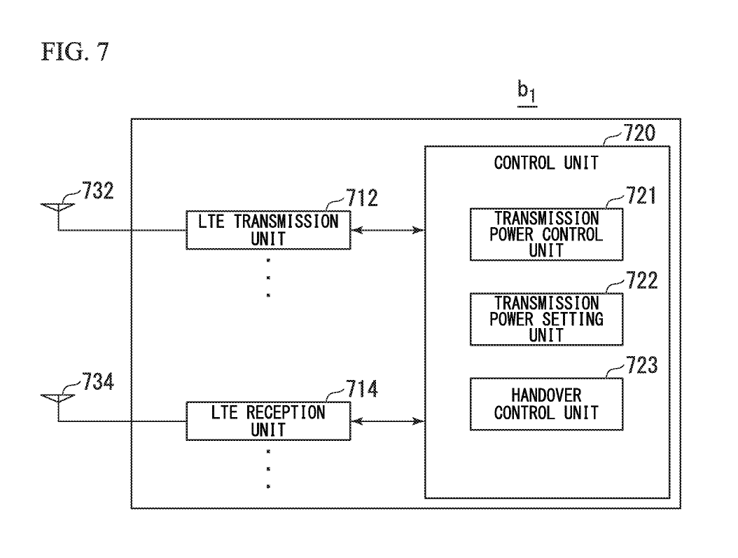

FIG. 7 is a simplified block diagram showing the constitution of the base station b₁ (FIG. 1). The base station b₁ is constituted to include an LTE transmission unit 712, an LTE reception unit 714, and a control unit 720. The base station b₁ has antennas 732 and 734, which are connected to the transmission unit and the reception unit, respectively. The LTE transmission unit 712 and the LTE reception unit 714 transmit and receive, respectively, on the band B. The base station b₁ uses the uplink component carrier and the downlink component carrier of S_{Cell1} that are paired to transmit and receive signals by the LTE transmission unit 712 and the LTE reception unit 714, respectively, and uses the downlink of S_{Cell2} to transmit a signal by the LTE transmission unit 712.

The control unit 720 is constituted to include a transmission power control unit 721, a transmission power setting unit 722, and a handover control unit 723.

The transmission power control unit 721 controls the transmission power of the antenna 732. The transmission power setting unit 722 sets the transmission power and passes the transmission power setting information to the transmission power control unit 721. The handover control unit 723 executes handover, following instructions from the base station a₁.

The constitution of the base station a₂ is the same as that of the base station a₁.

The constitution of the base station b₂ is the same as that of the base station b₁.

The terminal a: (1) can connect to one base station (for example the base station a₁) using only one component carrier each on uplink and downlink; (2) can connect to one base station (for example, the base station a₁) using an uplink and downlink component carrier, wherein there are two or a greater number of component carriers of at least one of the downlink or downlink. Additionally, (3) the terminal a can connect with two base stations (for example, the base station a₁ and the base station b₁) using the uplink and downlink component carriers, wherein number of each of the component carriers is one or greater. The above-noted (2) is intrasite carrier aggregation connection, and (3) is carrier aggregation dual connection (intersite carrier aggregation connection). The communication system 1 of FIG. 1 is the above-noted case of (3).

When making the above-noted (3) carrier aggregation dual connection, the terminal a performs the following processing.

[Processing 1]

The transmission power summing unit 525 of the terminal a, when making a first carrier aggregation dual connection, determines the transmission power sum S_{T} and the individual transmission powers Tₐ₁ and T_{b1}, and starts to periodically report these via the LTE transmission unit 511 and the antenna 531 to the base station a₁, which is the anchor base station. Upon receiving this, the base station a₁ temporarily stores the transmission power sum S_{T} and the transmission powers Tₐ₁ and T_{b1} into the storage unit 6232 of the transmission/reception quality determination unit 623 and periodically monitors the numerical change of the transmission power sum S_{T} by the determination unit 6231. The storage unit 6232 stores the above-described thresholds T_{HST}, THₐ₁, and T_{Hb1}. The determination unit 5241 of the base station a₁ performs the following processing upon determining that the transmission power sum S_{T} has exceeded the threshold T_{HST}. Specifically, the base station a₁ issues an instruction to the terminal a to measure surrounding cells. More specifically, as described earlier, it makes an instruction regarding a different type of base station (macro base station, small base station) that should be searched for, giving consideration also to whether or not the transmission powers Tₐ₁ and T_{b1} have exceeded the thresholds T_{Ha1} and T_{Hb1}, respectively.

The terminal a performs a search of surrounding cells based on this instruction, and reports to the base station a₁ in sequence of increasing transmission power sum thereof. The transmission power sum of the surrounding cells regarding the base station can, for example, be obtained by receiving a broadcast signal transmitted by the base stations of the surrounding cells.

If the base station a₁ discovers a surrounding cell having an uplink transmission power sum value obtained based on this report that is smaller than the threshold T_{HST} stored in the above-noted storage unit, the base station a₁ makes an instruction to the terminal a and to another related base station to make a handover to a base station for which a low transmission power sum will be sufficient. That is, an instruction is made to switch from the base station a₁ that had been communicating with the terminal a to the base station a₂ (the case of the Example A in FIG. 3), an instruction is made to switch from base station a₁ to base station a₂ and also to switch from base station b1 to base station b₂ (the case of the Example B in FIG. 3), or an instruction is made to switch from the base station b₁ to the base station b₂ (the case of the Example C in FIG. 3).

[Processing 2]

Processing can be done with greater accuracy by using the RSRP or the RSRQ rather than the transmission power sum, which is explained as follows. First, the terminal a starts periodically reporting the RSRP or the RSRQ to the base station a₁. Upon receiving this, the base station a₁ temporarily stores the uplink transmission power sum and RSPR or RSRQ into the storage unit of the transmission/reception quality determination unit 623. The terminal a₁ monitors the uplink transmission power sum and variation of the RSRP or the RSRQ. Next, when the uplink transmission power sum value exceeds a prescribed threshold and when the RSRP or the RSRQ falls below a prescribed threshold, the base station a₁ performs the following processing. Specifically, the base station a₁ issues an instruction to the terminal a to measure surrounding cells.

The terminal a performs a search of surrounding cells and reports to the base station a₁ base stations having a low uplink transmission power sum, in sequence of decreasing RSRP or RSRQ. More specifically, this report is made to the base station a₁, from among the base stations having an overall value of the RSRP or RSRQ that is the reception quality of a radio signal received by the surrounding base stations, which is higher than a prescribed threshold (threshold T_{Ha1} or T_{Hb1}), in the priority sequence of increasing overall value of the uplink transmission power from the terminal a, relative to the threshold (T_{HST}).

Based on this report, the base station a₁ makes an instruction to perform handover.

[Processing 3]

Upon a user switching the terminal a from the normal more to the power-saving mode, the above-noted Processing 1 or Processing 2 is performed. For that reason, the terminal a has an input device (not shown in FIG. 5) that accepts an instruction from the user, and the user makes an instruction to make the above switching using the input device.

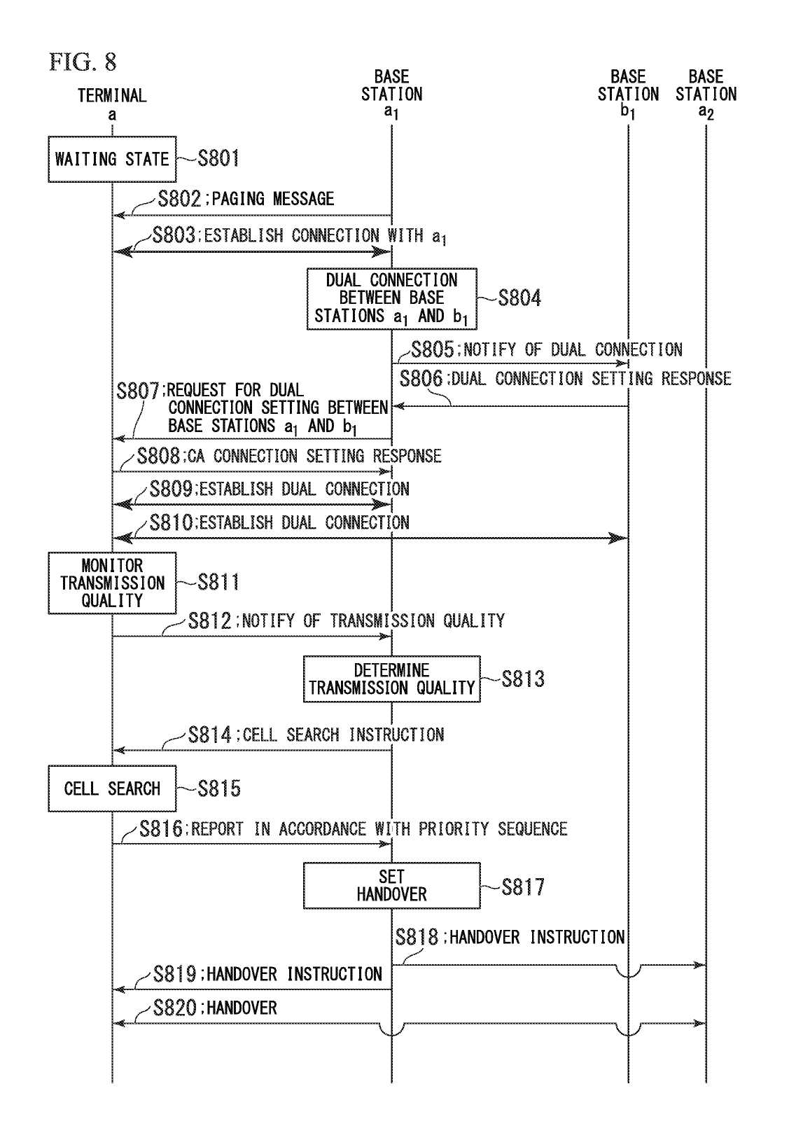

FIG. 8 is an operational sequence diagram showing terminal a handover in the communication system 1 (FIG. 1), and particularly showing the handover of the example (A) of FIG. 3.

(Step S801) First, the terminal a waits for the base station a₁ (waiting state, idle state).

(Step S802) The base station a₁ transmits a paging message to the terminal a using P_{Cell}. This paging (radio calling) transmits information of a signal protocol in a radio zone.

(Step S803) Connection between the terminal a and the base station a₁ is established.

(Step S804) A dual connection is made, by connection made with the base station a₁ by the terminal a using carrier aggregation and connection made with the base station b₁ by the terminal a using carrier aggregation.

(Step S805) The base station a₁ notifies the base station b₁ of the dual connection determined at step S804.

(Step S806) The base station b₁ returns a dual connection setting response to the base station a₁ to the effect that it is ready for the above-noted dual connection.

(Step S807) The base station a₁ transmits to the base station a₁ a dual connection setting request that requests the terminal a to make the setting of a dual connection between the base station a₁ and the base station b₁.

(Step S808) The terminal a returns a carrier aggregation connection setting response to the base station a₁.

(Step S809 and Step S810) The dual connection of the connection between the terminal a and the base station a₁ by carrier aggregation and the connection between the terminal a and the base station b₁ by carrier aggregation is established. The terminal a, by the above protocol, establishes a connection (dual connection), by a carrier aggregation connection using the two component carriers P_{Cell} and S_{Cell1} on the uplink, and a carrier aggregation connection using the four component carriers P_{Cell}, S_{Cell0},S_{Cell1}, and S_{Cell2} on the downlink.

(Step S811) The transmission/reception quality determination unit 623 of the terminal a monitors the transmission quality. This transmission quality is the above-described transmission power sum S_{T} and the transmission powers Tₐ₁ and T_{b1}.

(Step S812) The terminal a notifies base station a₁ of the transmission quality monitored at step S811.

(Step S813) The transmission/reception quality determination unit 623 of the base station a₁ determines whether or not the transmission power sum S_{T} about which notification was made from the terminal a exceeds the threshold T_{HC}.

(Step S814) If the base station a₁ determines that the transmission power sum S_{T} has exceeded the threshold THC, and particularly if it determines what base station of a different type to search for, an instruction is given to the terminal a to search for a macro base station.

(Step S815) The terminal a performs a cell search regarding macro base stations.

(Step S816) The terminal a, regarding the cell search results, makes a report to the base station a₁ in accordance with the priority sequence of the macro cell base stations being searched (which the priority higher, the low is the transmission power that the base station can use).

(Step S817) The terminal a, in accordance with the above-noted priority sequence, makes a handover to a base station (base station a₂) for which smaller transmission power is sufficient.

(Step S818) The base station a₁ instructs the base station a₂ to make a handover to establish communication with the terminal a.

(Step S819) The base station a₁ instructs the terminal a to make a handover to establish communication with the base station a₂.

(Step S820) The processing of the terminal a performing a handover of the other party in communication from the base station a₁ to the base station a₂ is completed.

In the above-noted handover protocol, handover between small base stations is not executed.

With regard to the handover example (B) and (C) as well, a specific states of the operational sequence are the same as the above-described example (A).

(Effect)

According to the first embodiment of the present invention, in a carrier aggregation dual connection, it is possible to execute a handover to a cell surrounding the terminal a, while controlling the transmission power of the terminal a.

Various embodiments capable of reducing the transmission power without the terminal a requiring handover will be described.

### Second Embodiment

The transmission power summing unit 525 of the terminal a, in making the first carrier aggregation connection, determines the transmission power sum S_{T}. At the point in time at which the transmission power sum S_{T} exceeds the threshold T_{HST}, the terminal a performs the processing shown below. The point in time at which the transmission power sum S_{T} exceeds the threshold T_{HST}may the time of the first carrier aggregation connection, and may be the point at which some time has elapsed thereafter. This can be the case in which the terminal a makes a carrier aggregation connection with one base station (for example the base station a₁) or the case in which a carrier aggregation connection is made to two base stations (for example, the base station a₁ and the base station b₁), this being the case of a carrier aggregation dual connection. This point applies to the embodiments hereinafter as well.

[Processing 1]

The transmission power setting unit 522 of the terminal a transmits only a control signal to a component carrier having a high transmission power. Note that if the terminal a is connected to two base stations (for example the base station a₁ and the base station b₁) using two or more component carriers, transmission of the control signal only is done to the component carrier of the component carrier with respect to each thereof that has a high transmission power.

[Processing 2]

The transmission power setting unit 522 of the terminal a reduces the amount of data transmitted to a component carrier having a high transmission power. When doing this, the transmission power setting unit 522 of the terminal a may increase the amount of data transmitted to a component carriers having a low transmission power. In doing this, although it is desirable that the upper limit of the transmission power with respect to the individual component carriers be within plus 30%, preferably within plus 20%, and further preferably within plus 10%, relative to the average value thereof, this is not a restriction. The transmitted data when the transmission power setting unit 522 of the terminal a reduces the amount of data transmitted to the component carrier with a high transmission power may include only a control signal. This means that the proportion of communication with a component carrier requiring only a small transmission power is increased. By doing this, the terminal a suppressing the overall transmission power.

(Effect)

When making a carrier aggregation connection, by increasing the proportion of communication with a component carrier requiring only a small transmission power, the power consumption of the terminal can be reduced, without performing handover. Additionally, this processing can be performed simply, without the involvement of the base station a₁.

### Third Embodiment

The transmission power summing unit 525 of the terminal a, when the first carrier aggregation connection is made, determines the transmission power sum S_{C0} regarding the carrier aggregation connection. Next, the transmission power summing unit 525 of the terminal a performs the following processing at the point in time at which the transmission power sum S_{C} has increased by a prescribed amount of increase D and has become the transmission power sum S_{C1}.

S_{C1}=S_{C0}+D (7)

The transmission power setting unit 522 of the terminal a decreases the amount of data transmitted to a component carrier having a high transmission power. In doing this, although it is desirable that the upper limit of the transmission power with respect to the individual component carriers be within plus 30%, preferably within plus 20%, and further preferably within 10%, relative to the average value thereof, this is not a restriction. When doing this, the transmission power setting unit 522 of the terminal a may increase the amount of data transmitted to a component carriers having a low transmission power. The transmitted data when the terminal a reduces the amount of data transmitted to the component carrier with a high transmission power may include only control data. This means that the proportion of communication with a component carrier requiring only a small transmission power is increased. By doing this, the terminal a suppressing the overall transmission power.

(Effect)

When carrier aggregation is done, the terminal a, by increasing the proportion of communication with a component carrier requiring only a small amount of transmission power, can reduce the terminal power consumption, without performing handover. Additionally, this processing can be performed simply by the terminal a, without the involvement of the base station a₁. Also, because a fixed (absolute value) threshold is not used, processing is flexible.

### Fourth Embodiment

The transmission power summing unit 525 of the terminal a, when the first carrier aggregation connection or carrier aggregation dual connection is made, determines the transmission powers with respect to the individual component carriers. Next, the terminal a reduces the amount of data transmitted to a component carrier having a high transmission power. In doing this, although it is desirable that the upper limit of the transmission power with respect to the individual component carriers be within plus 30%, preferably within plus 20%, and further preferably within 10%, this is not a restriction. When this is done, the amount of data transmitted to a component carrier having a small transmission power may be increased.

(Effect)

When the first carrier aggregation connection or carrier aggregation dual connection is made, the terminal a, by increasing the proportion of communication with a component carrier requiring only a small amount of transmission power, can reduce the terminal power consumption without performing handover. Additionally, this processing can be performed simply by the terminal a, without the involvement of the terminal al. Also because the component carrier transmission power control is done directly when the first carrier aggregation connection or carrier aggregation dual connection is made, there is an effective power savings in the terminal a.

### Fifth Embodiment

The first to the fourth embodiment is applied in the case in which the terminal a is carrier aggregation connected, and when the connection is expanded to three or a larger number of base station. That is, if the terminal a transmits communication data to three or a larger number of base stations, the amount of data transmitted to the component carrier of a base station having a large uplink transmission power is reduced, in accordance with the first to the fourth embodiments.

For example, if there are three or more base stations carrier aggregation (dual) connected, data transmission is done only by the base station having the smallest transmission power, and transmission is done to the other base station of a control signal only.

### Sixth Embodiment

Upon the user switching the terminal a from the normal mode to the power-saving mode, the above-noted embodiments are implemented.

<Notes>

The embodiment of the present invention can be practiced in the following forms.

Note 1

A terminal comprising:

a transmission power setting unit configured to set transmission powers of two or a greater number of uplink component carriers connecting one or a greater number of base stations;

a transmission power control unit configured to control the transmission powers based on information from the transmission power setting unit;

a transmission power summing unit configured to determine a sum of the transmission powers of the uplink component carriers; and

a handover control unit configured to execute a handover at a point in time at which the sum of the transmission powers of the uplink component carriers exceeds a prescribed threshold.

Note 2

A terminal constituted comprising:

a transmission power setting unit configured to set transmission powers of two or a greater number of uplink component carriers connecting one or a greater number of base stations;

a transmission power control unit configured to control the transmission powers based on information from the transmission power setting unit;

a transmission power summing unit configured to determine a sum of the transmission powers of the uplink component carriers;

a component carrier measurement unit configured to determine a sum of reception qualities of radio signals received from the base station on two or a larger number of downlink component carriers;

an overall evaluation unit configured to determine an overall evaluation from the sum of the transmission powers and the sum of the reception qualities; and

a handover control unit configured to execute a handover at a point in time in a case that the overall evaluation exceeds a prescribed threshold.

Note 3

A base station that is connected to a terminal and also connected to another base station and that is connected to the terminal by a carrier aggregation connection, the base station comprising:

a determination unit configured to determine a sum of transmission powers of uplink component carriers of the terminal a transmitted from the terminal exceeding a prescribed threshold; and

a handover control unit configured to execute a handover at a point in time at which the sum of the transmission powers exceeds the threshold.

Note 4

A base station that is connected to a terminal and also connected to another base station and that is connected to the terminal by a carrier aggregation connection, the base station comprising:

a determination unit configured to determine an overall evaluation determined from a sum of transmission powers of uplink component carriers of the terminal a transmitted from the terminal and a sum of reception qualities of receiving radio signals of the terminal exceeding a prescribed threshold; and

a handover control unit configured to execute a handover at a point in time at which the overall evaluation exceeds the threshold.

Note 5

A communication method comprising:

acquiring a first uplink transmission power from a terminal to one base station that performs a heterogeneous communication;

acquiring a second uplink transmission power from a terminal to a different base station that performs a heterogeneous communication;

acquiring a sum of uplink transmission power that includes at least the first and the second uplink transmission powers; and

executing a handover at a point in time at which the sum of the transmission powers exceeds a prescribed threshold.

Note 6

A communication method comprising:

acquiring a first uplink transmission power from a terminal to one base station that performs a heterogeneous communication;

acquiring a second uplink transmission power from a terminal to a different base station that performs a heterogeneous communication;

acquiring a sum of uplink transmission powers that include at least the first and the second uplink transmission powers;

acquiring a first downlink reception quality from one base station to the terminal performing the heterogeneous communication;

acquiring a second downlink reception quality from another base station to the terminal performing the heterogeneous communication;

acquiring a sum of downlink reception qualities including at least the first and the second downlink reception qualities;

determining an overall evaluation from the sum of the transmission powers and the sum of the reception qualities; and

executing a handover at a point in time at which the sum of the transmission powers exceeds a prescribed threshold.

Note 7

A communication method comprising:

determining a sum of transmission powers of uplink component carriers of a terminal at a first carrier aggregation connection of the terminal; and

at a point in time that the sum of the transmission powers exceeds a prescribed threshold, reducing a transmission power with respect to a component carrier having a high transmission power, and increasing a proportion of a communication of a terminal with a component carrier requiring only a small transmission power.

Note 8

A communication method comprising:

determining a sum of transmission powers of uplink component carriers of a terminal at a first carrier aggregation connection of the terminal; and

at a point in time that the sum of first transmission powers has increased by a prescribed amount of increase, reducing a transmission power with respect to a component carrier having a high transmission power, and increasing a proportion of a communication of a terminal with a component carrier requiring only a small transmission power.

Note 9

A communication method comprising:

determining individual transmission powers of uplink component carriers of a terminal at a first carrier aggregation connection of the terminal; and

reducing a transmission power with respect to a component carrier having a high transmission power, and increasing a proportion of a communication of a terminal with a component carrier requiring only a small transmission power, so that an upper limit of a transmission power with respect to individual component carriers is held within 30%, and preferably within 20%, and more preferably within 10%, relative to an average value thereof.

Although embodiments of the present invention have been described in detail, with reference made to the drawings, the specific constitution is not restricted to the foregoing, and can be subjected to various design changes, within the scope of the spirit of the present invention.

### INDUSTRIAL APPLICABILITY

An aspect of the present invention can be used in the field of art of carrier aggregation dual connection in LTE-A and in similar fields of art.

### DESCRIPTION OF THE REFERENCE SYMBOLS

a Terminal
a₁, a₂ Macro base station
b₁, b₂ Small base station
Cₐ₁, Cₐ₂, C_{b1}, C_{b2} Communication area
P_{Cell} Primary cell
S_{Cell} Secondary cell

1. A terminal comprising:
a transmission power setting unit configured to set transmission powers of two or a greater number of uplink component carriers connecting one or a greater number of base stations;
a transmission power control unit configured to control the transmission powers based on information from the transmission power setting unit;
a transmission power summing unit configured to determine a sum of the transmission powers of the uplink component carriers; and
a power-reduction processing unit configured to, in a case that the sum of the transmission powers exceeds a prescribed threshold, start processing for reducing a power consumption.

2. The terminal according to claim 1,
wherein the power-reduction processing unit is configured to reduce the power consumption by changing the amount of data transmitted using the component carriers or by executing a handover.

3. A terminal comprising:
a transmission power setting unit configured to set transmission powers of two or a greater number of uplink component carriers connecting one or a greater number of base stations;
a transmission power control unit configured to control the transmission powers based on information from the transmission power setting unit;
a transmission power summing unit configured to determine a sum of the transmission powers of the uplink component carriers;
a component carrier measurement unit configured to determine a sum of the reception qualities of radio signals received from the base station using two or a larger number of downlink component carriers;
an overall evaluation unit configured to determine an overall evaluation from the sum of the transmission powers and the sum of the reception qualities; and
a handover control unit configured to execute a handover in a case that the overall evaluation exceeds a prescribed threshold.

4. A base station that is connected to a terminal and also connected to another base station and that is connected to the terminal by a carrier aggregation connection, the base station comprising:
a determination unit configured to determine a sum of transmission powers of uplink component carriers of the terminal transmitted from the terminal exceeding a prescribed threshold; and
a handover control unit configured to cause the terminal to execute a handover in a case that the sum of the transmission powers exceeds the threshold.

5. A base station that is connected to a terminal and also connected to another base station and that is connected to the terminal by a carrier aggregation connection, the base station comprising:
a determination unit configured to determine an overall evaluation determined from a sum of transmission powers of uplink component carriers of the terminal transmitted from the terminal and a sum of reception qualities of receiving radio signals of the terminal exceeding a prescribed threshold; and
a handover control unit configured to cause for the terminal to execute a handover in a case that the overall evaluation exceeds the threshold.
